(19) United States
(12) Patent Application Publication
(10) Pub. No.: US 2005/0274200 A1
(43) Pub. Date: Dec. 15, 2005

(54) Flowmeter batching techniques

(76) Inventors: Manus P. Henry, Oxford (GB); Feibiao Zhou, Oxford (GB)

Correspondence Address: FISH & RICHARDSON P.C., P.O. BOX 1022, MINNEAPOLIS, MN, 55440-1022, US

(21) Appl. No.: 11/136,728

(22) Filed: May 25, 2005

Related U.S. Application Data
(60) Provisional application No. 60/573,834, filed on May 25, 2004.

(51) Int. Cl. G01F 1/84

(52) U.S. Cl. 73/861.356

(57) ABSTRACT

In a filling system, a flow rate of a material being dispensed is determined while the material is being dispensed and used to estimate a run-off amount of the material being dispensed. The estimate of the run-off is then used to determine a valve closure time for closing a valve that controls a flow of the material.

### CROSS-REFERENCE TO RELATED APPLICATIONS

This application claims priority to U.S. Provisional Application Ser. No. 60/573,834, titled FLOWMETER BATCHING TECHNIQUES, and filed on May 25, 2004.

### TECHNICAL FIELD

This description relates to the use of flowmeters in filling systems.

### BACKGROUND

Flowmeters provide information about materials being transferred through a conduit. For example, mass flowmeters provide a measurement of the mass of material being transferred through a conduit. Similarly, density flowmeters, or densitometers, provide a measurement of the density of material flowing through a conduit. Mass flowmeters also may provide a measurement of the density of the material.

For example, Coriolis-type mass flowmeters are based on the Coriolis effect, in which material flowing through a rotating conduit is affected by a Coriolis force and therefore experiences an acceleration. Many Coriolis-type mass flowmeters induce a Coriolis force by sinusoidally oscillating a conduit about a pivot axis orthogonal to the length of the conduit. In such mass flowmeters, the Coriolis reaction force experienced by the traveling fluid mass is transferred to the conduit itself and is manifested as a deflection or offset of the conduit in the direction of the Coriolis force vector in the plane of rotation.

### SUMMARY

In one general aspect, a method of operating a filling system includes opening a valve to start a flow of material through a conduit. While the material is flowing through the conduit, a total amount of the material that has flowed through the conduit, and a flow rate of the material flowing through the conduit are determined. A run-off amount of the material flowing through the conduit is estimated based on the flow rate. In response to determining that the total amount of the material that has flowed through the conduit plus the run-off amount is greater than or equal to a target amount, a closure of the valve is initiated to stop the flow of material through the conduit.

Implementations may include one or more of the following features. For example, the total amount may be a total mass or total volume, the flow rate may be a mass flow rate or volumetric flow rate, and the target amount may be a target volume.

The total amount of the material that has flowed through the conduit may be determined by calculating TOTₜ=TOTₜ₋₁+MₜΔt, where TOTₜ is the total amount of the material that has flowed through the flowtube up to present time t, TOTₜ₋₁ is the total amount of the material that has flowed through flowtube up to time t-1, Mₜ is the flow rate at time t, and Δt is the interval between time t and t-1. Alternatively, or additionally, determining the total amount of the material that has flowed through the conduit may include counting pulses output by a Coriolis flowmeter, wherein each pulse output by the Coriolis flowmeter represents a unit amount of material.

Determining the flow rate of the material flowing through the conduit may include oscillating the conduit; sensing a property of the oscillation of the conduit; and calculating the flow rate based on the sensed property. Alternatively, or additionally, determining the flow rate of the material flowing through the conduit may include reading a signal from a Coriolis flowmeter, wherein the signal indicates the flow rate.

Estimating the run-off amount may include calculating R=X+Mₜ*Y, where R is the estimated run-off amount, X is a constant amount, Mₜ is the flow rate at present time t, and Y is a run-off time characteristic. The closure of the valve may be initiated less than about 5 seconds after opening the valve.

In another general aspect, a flowmeter transmitter includes a parameter determination system and a batch control system. The parameter determination system is configured to determine a flow rate of a material traveling through a flowtube. The batch control system is configured to estimate a run-off amount of the material based on the flow rate and to determine a valve closure time for a valve associated with the flowtube based on the estimated run-off amount.

Implementations may include one or more of the following features. For example, the flowmeter transmitter may be a digital Coriolis flowmeter transmitter.

The parameter determination system may be configured to determine a total amount of material that has travelled through the flowtube, and the batch control system may be configured determine the valve closure time based on the estimated run-off amount and the total amount of material that has travelled through the flowtube. The total amount may be a total mass or total volume, the flow rate may be a mass flow rate or volumetric flow rate, and the target amount may be a target volume.

In either case, the parameter determination system may be configured to determine the total amount of material that has travelled through the flowtube by performing the following calculation: TOTₜ=TOTₜ₋₁+MₜΔt, where TOTₜ is the total amount of the material that has travelled through the flowtube up to present time t, TOTₜ₋₁ is the total amount of the material that has travelled through flowtube up to time t-1, Mₜ is the flow rate at time t, and Δt is the interval between time t and t-1.

The batch control system may be configured to determine the valve closure time by determining whether TOTₜ+R>=target2, where TOTₜ is the total amount of material that has travelled through the flowtube up to present time t, R is the estimated run-off amount, and target2 is a target amount. The batch control system may be configured to estimate the run-off amount by calculating R=X+Mₜ*Y, where R is the estimated run-off amount, X is a constant amount, Mₜ is the flow rate at present time t, and Y is a run-off time characteristic. The batch control system may be configured to initiate closing of the valve when the valve closure time occurs.

In another general aspect, a filling system includes a conduit to receive a flow of material and a valve to start and stop the flow of material through the conduit. The filling system further includes at least one sensor connected to the conduit and one or more processing devices to receive a sensor signal from the sensor and configured to determine a flow rate of the flow of material based on the sensor signal, to estimate a run-off amount of the flow of material based on the flow rate, and to determine a valve closure time based on the estimate of the run-off amount.

Implementations may include one or more of the following features. For example, the total amount may be a total mass or total volume, the flow rate may be a mass flow rate or volumetric flow rate, and the target amount may be a target volume.

The one or more processing devices may be configured to determine a total amount of material that has flowed through the conduit and to determine the valve closure time based on the estimated run-off amount and the total amount of material that has flowed through the conduit. The one or more processing devices may be configured to determine the total amount of material that has flowed through the conduit by performing the following calculation: TOTₜ=TOTₜ₋₁+MₜΔt, where TOTₜ is the total amount of the material that has flowed through the conduit up to present time t, TOTₜ₋₁ is the total amount of the material that has flowed through conduit up to time t-1, Mₜ is the flow rate at time t, and Δt is the interval between time t and t-1.

The one or more processing devices are configured to determine the valve closure time by determining whether TOTₜ+R>=target2, where TOTₜ is the total amount of material that has flowed through the conduit up to present time t, R is the estimated run-off amount, and target2 is a target amount. Also, the one or more processing devices are configured to estimate the run-off amount by calculating R=X+Mₜ*Y, where R is the estimated run-off amount, X is a constant amount, Mt is the flow rate at present time t, and Y is a run-off time characteristic.

The one or more processing devices may include a digital Coriolis transmitter processor configured to determine the flow rate of the flow of material based on the sensor signal, to estimate the run-off amount of the flow of material based on the flow rate, and to determine the valve closure time based on the estimate of the run-off amount. Alternatively, the one or more processing devices may include a digital Coriolis transmitter processor configured to determine the flow rate of the flow of material based on the sensor signal, and a programmable logic controller configured to estimate the run-off amount of the flow of material based on the flow rate, and to determine the valve closure time based on the estimate of the run-off amount.

The details of one or more implementations are set forth in the accompanying drawings and the description below. Other features will be apparent from the description and drawings, and from the claims.

### DESCRIPTION OF DRAWINGS

FIG. 1A is an illustration of a Coriolis flowmeter using a bent flowtube.

FIG. 1B is an illustration of a Coriolis flowmeter using a straight flowtube.

FIG. 2 is a block diagram of a filling system using a Coriolis flowmeter.

FIG. 3 is a graph illustrating short batches using a double diaphragm pump.

FIG. 4 is a block diagram of a filling system using a Coriolis flowmeter and PLC.

FIG. 5 is a flowchart illustrating a process for determining a valve closure time based on an estimate of product run-off.

FIG. 6 is a graph showing a nominal step response of a variety of flowmeters.

FIG. 7 is a graph showing results of a step response test using the flowmeter of FIG. 2.

FIGS. 8A-8D are graphs showing a response of 3 mm and 40 mm flowtubes to a step change.

FIGS. 9A-9D are graphs showing raw and corrected data for the configuration(s) of FIGS. 8A-8D, with small step changes.

### DETAILED DESCRIPTION

Types of flowmeters include digital flowmeters. For example, U.S. Pat. No. 6,311,136, which is hereby incorporated by reference in its entirety, discloses the use of a digital flowmeter and related technology. Such digital flowmeters may be very precise in their measurements, with little or negligible noise, and may be capable of enabling a wide range of positive and negative gains at the driver circuitry for driving the conduit. Such digital flowmeters are thus advantageous in a variety of settings. For example, commonly-assigned U.S. Pat. No. 6,505,519, which is hereby incorporated by reference in its entirety, discloses the use of a wide gain range, and/or the use of negative gain, to prevent stalling and to more accurately exercise control of the flowtube, even during difficult conditions such as two-phase flow.

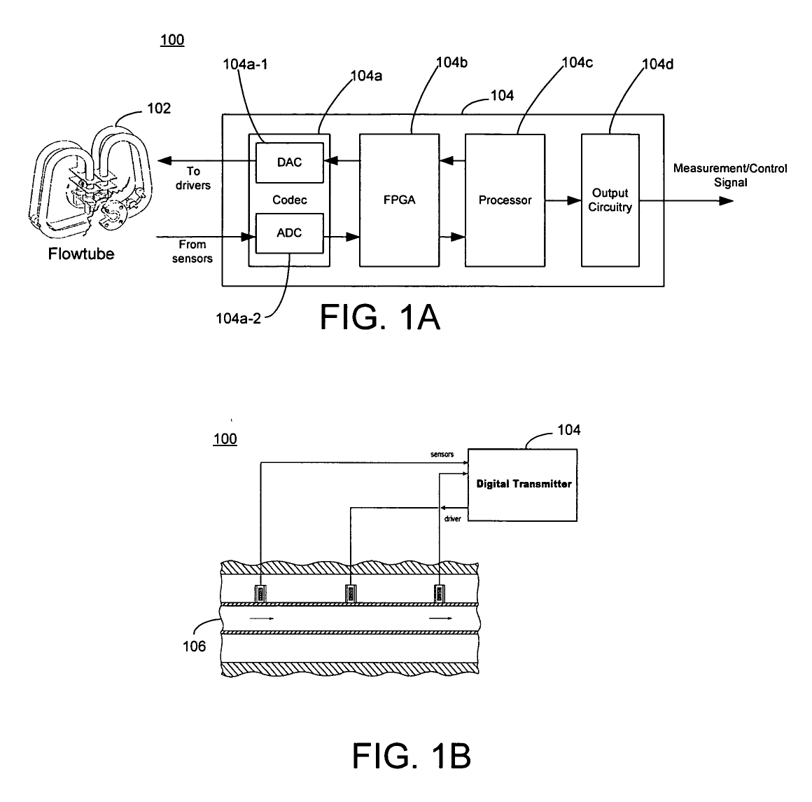

Although digital flowmeters are specifically discussed below with respect to FIGS. 1A, 1B, 2, and 4, it should be understood that analog flowmeters also exist. Although such analog flowmeters may be prone to typical shortcomings of analog circuitry, e.g., low precision and high noise measurements relative to digital flowmeters, they also may be compatible with the various techniques and implementations discussed herein. Thus, in the following discussion, the term “flowmeter” or “meter” is used to refer to any type of device and/or system in which various control systems and related elements interact with a flowtube or other conduit to measure a mass flow, density, and/or other parameters of a material(s) moving through the flowtube/conduit.

FIG. 1A is an illustration of a digital Coriolis flowmeter 100. Generally, a Coriolis flowmeter, such as flowmeter 100, may include two sections: a flowtube 102 and a transmitter 104. Flowtube 102 is a mechanical component providing the pipework through which material flows, including a measurement section which is able to oscillate, along with (usually) coil-based sensor(s) and driver(s) to monitor and maintain the flowtube oscillations. Transmitter 104 is an electronic device with electrical connections to the sensors and drivers of the flowtube. The tasks of transmitter 104 are, for example, to initiate and maintain flowtube oscillation and to extract mass flow rate, density and possibly other data from the sensor signals.

In short, a basic principle of Coriolis flow metering, e.g., for industrial flow measurement, is that the flowtube 102 is caused to vibrate sinusoidally at a resonant frequency by the drivers, while the sensors monitor the vibration. The flowtube geometry and sensor placement are arranged so that the frequency of oscillation (which may vary, e.g., from 50 Hz to 1000 Hz for different flowtube designs) may be used to calculate the density of the process fluid, while the phase difference between the two sensor signals provides the mass flow rate.

In FIG. 1A, flowtube 102 is a bent flowtube and transmitter 104 is a digital transmitter. A detailed description of a structure and operation(s) of a bent flowtube, such as bent flowtube 102, is provided in, for example, commonly-assigned U.S. Pat. No. 6,311,136.

Transmitter 104 is ‘digital’ in that the components of transmitter 104, other than elementary front end circuitry, are digital devices. Specifically, the drive waveform used to initiate and maintain flowtube oscillation is synthesised digitally, and the measurement calculations are performed digitally. This facilitates high speed, high precision measurement and control calculations.

In general, digital transmitter 104 exchanges sensor and drive signals with bent flowtube 102, so as to both sense an oscillation of the bent flowtube 102, and to drive the oscillation of the bent flowtube 102 while a process fluid or other material is traveling through bent flowtube 102. By quickly and accurately determining the sensor and drive signals, digital transmitter 104 may provide for fast and accurate operation of the bent flowtube 102, and may provide for precise measurements of a parameter of the traveling fluid (e.g., mass flow rate and/or density).

Transmitter 104 may be implemented using one or more of, for example, a processor, a Digital Signal Processor (DSP), a field-programmable gate array (FPGA), an ASIC, other programmable logic or gate arrays, or programmable logic with a processor core. It should be understood that, as described in U.S. Pat. No. 6,311,136, associated digital-to-analog converters may be included for operation of the drivers, while analog-to-digital converters may be used to convert sensor signals from the sensors for use by the digital transmitter 104.

In the example shown in FIG. 1A, transmitter 104 includes an audio codec 104a, an FPGA 104b, a processor 104c, and output circuitry 104d. Audio codec 104a includes a digital-to-analog converter 104a-1 (e.g., a two channel digital-to-analog converter when two drivers are used) to convert digital drive signals from FPGA 104b into analog drive signals to be output to drivers associated with flowtube 102. In addition, audio codec 104a includes an analog-to-digital converter 104a-2 (e.g., a two channel analog-to-digital converter when two sensors are used) to convert analog sensor signals from the sensors associated with flowtube 102 into digital sensor signals to be output to FPGA 104b. Analog-to-digital converter 104a-2 may provide, for instance, 24 bit data at 40 kHz.

FPGA 104b is used for the real-time aspects of flowtube control such as the drive waveform synthesis, while processor 104c is used for other calculations, such as measurement or other data calculations (e.g., mass flow rate calculations, density calculations, or other calculations). Processor 104c outputs the measurement or other data calculations to output circuitry 104d, which conditions the measurement or other data calculations into a measurement/control signal for transmission to, for example, a process monitoring and/or control system (not shown). Instead of output circuitry, FPGA 104b may be configured to provide an output based on the measurement(s) from processor 104c. For example, if pulse output (described below and herein) is used to communicate the value of, e.g., mass flow rate, FPGA 104b may be used to produce the pulses.

Output circuitry 104d may, for example, condition the measurement or other data calculations into an industrial communication protocol. Presently there are three classes of commonly-used industrial communication protocols. First, there is 4-20 mA, where the flow rate is mapped onto an analog current signal between 4 and 20 mA. Second, there is pulse (frequency) output, which generally includes a square wave signal in which the frequency of the pulse stream gives an indication of the instantaneous flow rate. Third, fieldbus communications (including, for example, HART, Modbus, and Foundation Fieldbus) may be used. Such communication protocols allow the transmission of measurement data in floating point format, with no loss of precision.

For a bent flowtube, such as flowtube 102, the drive frequency may be in the range of 50-110 Hz, with processor 104c performing measurement updates every half-cycle (i.e. at 100-220 Hz), for example. However, transmitter 104 can drive other flowtube designs, including straight tube geometries (as shown and described with respect to FIG. 1B), with drive frequencies in the range of 300-1000 Hz, for example.

FIG. 1B is an illustration of a digital Coriolis flowmeter 100 using a straight flowtube 106. More specifically, in FIG. 1B, the straight flowtube 106 interacts with the digital transmitter 104. Such a straight flowtube operates similarly to the bent flowtube 102 on a conceptual level, and has various advantages/disadvantages relative to the bent flowtube 102. For example, the straight flowtube 106 may be easier to (completely) fill and empty than the bent flowtube 102, simply due to the geometry of its construction.

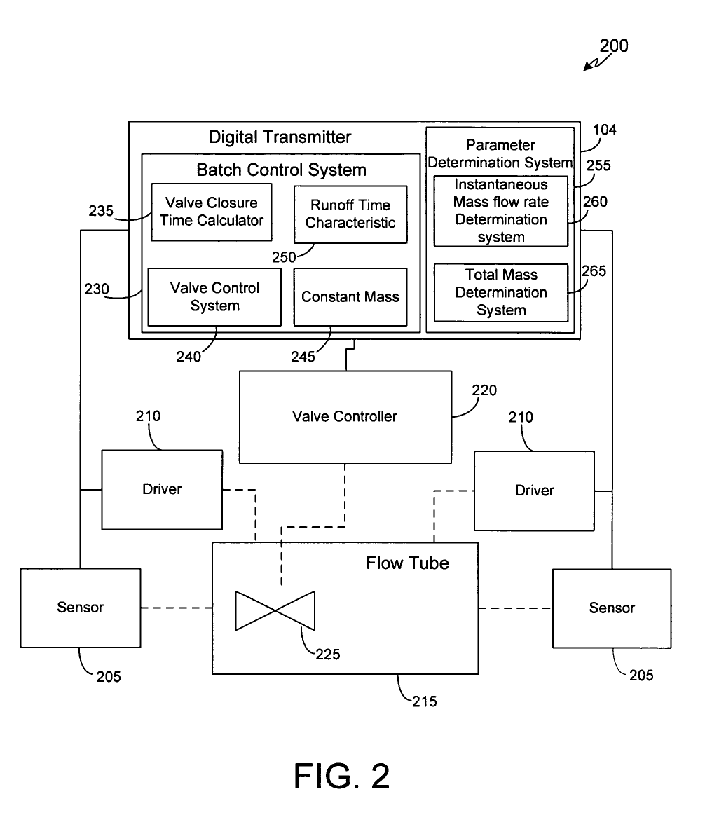

Referring to FIG. 2, a Coriolis flowmeter according to FIGS. 1A or 1B may be used in a filling system 200 that performs batching operations, i.e., operations in which multiple containers are each filled with a particular amount of a material. An example of a batching process includes the dispensing of batches of paint or other industrial material into container(s) of designated volume(s).

The digital Coriolis flowmeter includes the digital transmitter 104, one or more motion sensors 205, one or more drivers 210, and a flowtube 215 (which also may be referred to as a conduit, and which may represent either the bent flowtube 102, the straight flowtube 106, or some other type of flowtube). As described above, digital transmitter 104 controls the drivers 210 to induce oscillations in the flowtube 215, and the oscillations of flowtube 215 are sensed by the motion sensors 205, which may be positioned, for example, on a right and left side of the flowtube 215.

A valve controller 220 is connected to transmitter 104 and operates to open and close a valve 225 (which may or may not be a part of flowtube 215). Typically, a mechanism (not shown) such as a double-diaphragm pump or gravimetric hopper may drive the fluid flow through flowtube 215 and into a container (not shown). Valve 225 is opened and closed to respectively start and stop the flow of fluid through flowtube 225 and into the container.

In general, digital transmitter 104 uses the sensor signals to measure one or more parameters of the material flowing through flowtube 215, and uses the parameters to control the closing of valve 225 such that a target amount of the material is dispensed into the container. For example, if the amount of material to be dispensed is measured in mass, then the mass flow rate may be measured to determine when valve 225 should be closed to attain a target mass of material.

To that end, digital transmitter 104 includes a parameter determination system 255 and a batch control system 230. Parameter determination system 255 determines one or more parameters of the material flowing through flowtube 215, and the parameters are used by batch control system 230 to determine a valve closure time (VCT) that results in a target amount of material, such as paint, being dispensed into the container. When the VCT occurs, digital transmitter 104 instructs valve controller 220 to close valve 225.

Because of the mechanical response time of valve 225, there may be product run-off while valve 220 is closing. In other words, the material may still be dispensed into the container while valve 225 is closing.

In some systems the run-off may be negligible. For example, the batch time (i.e., the time the material flows for a single batch) in some systems is long enough that the time taken to close valve 225, and the resultant run-off, are negligible. In such systems, run-off may be ignored. However, in other systems, the run-off may not be negligible. For example, in short batching operations (e.g., where the fill time is less than about 5s), the valve closure time and resultant run-off may not be negligible because they can result in an unacceptable variation between the actual amount dispensed and the target amount.

When the run-off is not negligible, batch control system 230 may take into account such run-off when determining the VCT. In some systems, the run-off amount may be assumed to be a fixed amount. For such systems, the determination of the VCT may be determined by flow integration using a rule such as:
TOTₜ=TOTₜ₋₁+MₜΔₜ; If TOTₜ>=target1, VCT=t and shut valve (Eq 1)

In Eq 1, TOTₜ is the total mass that has been dispensed up to present time t, TOTₜ₋₁ is the total mass that has been dispensed up to time t-1, Mₜ is the instantaneous mass flow rate at time t, and Δt is the interval between measurement updates of the mass flow rate (i.e., the interval between calculations of a new value for the mass flow rate based on signals from sensors 205).

Because run-off is assumed to be a fixed amount, it is taken into account by setting target1 equal to the target amount minus the fixed run-off. The run-off amount may be assumed to be fixed, for example, for systems in which the mass flow rate for a batch, once established, remains substantially steady, or for systems in which the mass flow rate is the same near the end of each batch operation. In such systems, the run-off amount may remain substantially constant for each batch because the mass flow rate at the end of each batch is substantially the same, and any variations of the mass flow rate that do occur result in variations in the fill amount that are within acceptable limits. Accordingly, to correct for the run-off, the average amount of run-off may be determined experimentally and taken into account by making target1 equal to the target amount minus the average amount.

However, in some systems, the variation of the mass flow rate near the end of each batch operation may be substantial enough that variations in fill amounts due to variations in run-off amounts are outside the tolerable range for the system. For example, when a double diaphragm pump is used to drive the flow of material, the mass flow rate may vary over the pump cycle, for instance, by about 30%. As there is in general no guarantee that the start of a new batch coincides with the same point in the diaphragm pump cycle, consecutive batches will encounter different flow profiles and, accordingly, the flow rate at the valve closure time may be different on consecutive batches, possibly resulting in different run-off quantities.

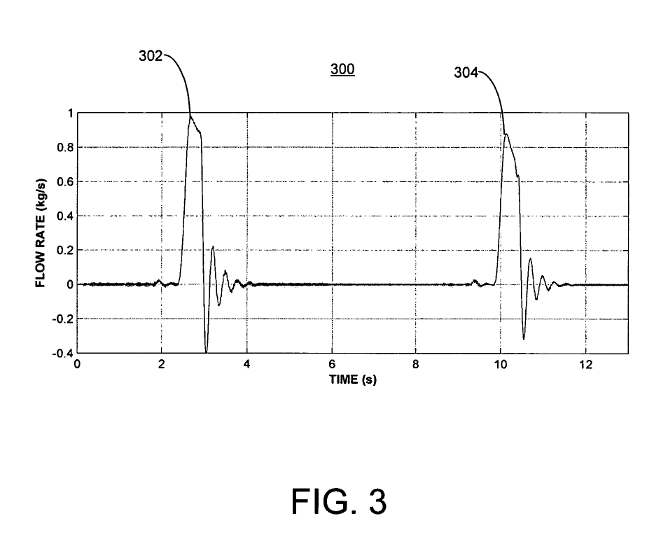

Referring momentarily to FIG. 3, a graph 300 illustrates different mass flow rates at the end of short batches when a double diaphragm pump is used. Graph 300 shows two consecutive batch runs in which containers are filled with paint, generating totals of 375 g in 1.11 s and 356 g in 1.14 s respectively. The flow rate at the end of each batch is quite different. As can be seen, the flow rate at the end of the first batch 302 is about 1 kg/s, while at the end of the second batch 304, the mass flow rate is about 0.9 kg/s. This variation in the mass flow rate is due to the action of the double diaphragm pump, and leads to a variable amount of product run-off once the valve begins to shut.

Accordingly, referring again to FIG. 2, in such situations, batch control system 230 may dynamically estimate the run-off during a batch operation based on the instantaneous mass flow rate, and use the estimate of the run-off when determining the VCT.

To do so, the run-off of the filling system may be approximated by:
R=X+M*Y (Eq. 2)
where X is a constant mass, M is the instantaneous mass flow rate at VCT, and Y is the runoff time characteristic of the filling system. The values of X and Y can be determined by experiment, by, for example, observing the values of R for different values of M. The rule for determining VCT is then:
TOTₜ=TOTₜ₋₁+MₜΔt;
If TOTₜ+X+Mₜ*Y>=target2, VCT=t and shut valve (Eq 3)
where target2 is equal to the target amount. Thus, for example, at each measurement update of the mass flow rate (which occur at intervals of Δt), this rule may be evaluated to determine whether valve 225 should be closed.

To implement such a rule, parameter determination system 255 includes an instantaneous mass flow rate determination system 260 for determining the value of the parameter Mₜ, as well as a total mass determination system 265 for determining TOTₜ. Batch control 230 includes a valve closure time calculator that evaluates Eq. 3 based on TOTₜ received from total mass flow rate determination system 265, Mₜ from instantaneous mass flow rate determination system 260, and the stored values of constant mass X 245 and runoff time characteristic Y 250. If valve closure time calculator 235 determines that TOTₜ+X+Mₜ*Y>=target2, then valve closure calculator 235 signals valve control system 240 that it is time to close valve 225. Valve control system consequently instructs valve controller 220 to close valve 225.

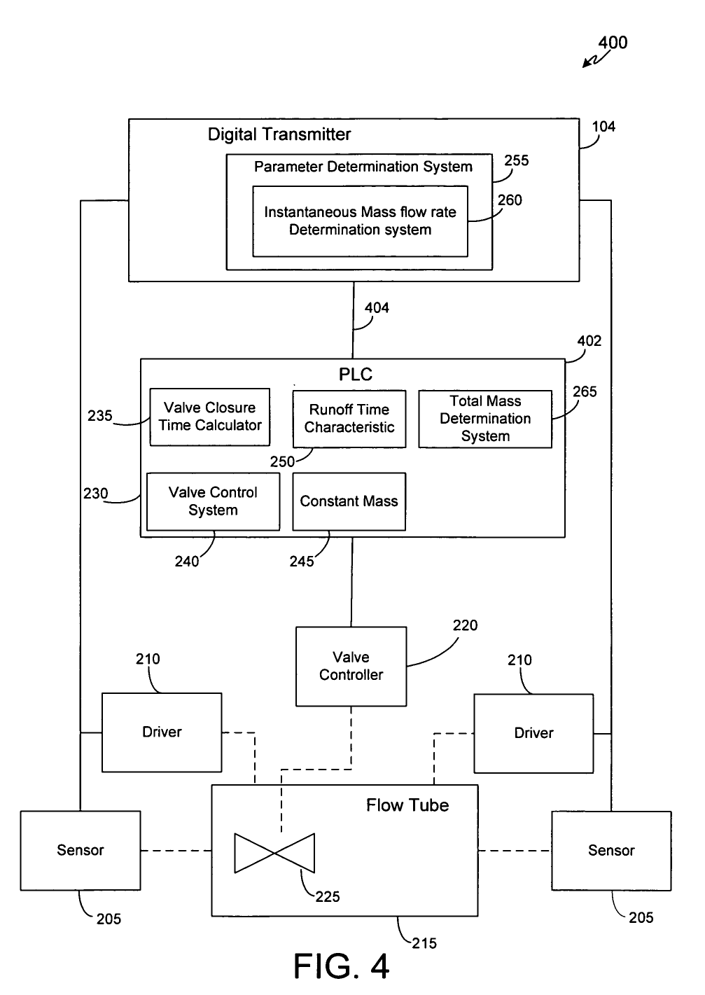

Referring to FIG. 4, in an alternate implementation, a Coriolis flowmeter according to FIGS. 1A or 1B may be used with a Programmable Logic Controller (PLC) 402 in a filling system 400 that performs batching operations. Implementation 400 is similar to the implementation shown in FIG. 2, except that PLC 402 determines the total mass TOTₜ and VCT based on one or more outputs 404 from digital transmitter 104 that reflect the mass flow rate. To that end, parameter determination system 255, including instantaneous mass flow rate determination system 260, is implemented by digital transmitter 104, while total mass determination system 265, valve closure time calculator 235, valve control system 240, constant mass 245, and run-off time characteristic are implemented by PLC 402.

In one implementation using PLC 402, digital transmitter 104 transmits the mass flow rate to PLC 402 using both pulse output and 4-20 mA. The pulse output representation is then used to perform the flow integration (determine TOTₜ) through pulse counting, while the 4-20 mA representation is used to estimate the run-off based on the instantaneous mass flow rate.

For example, a PLC program may run on PLC 402 every millisecond to perform the flow integration, estimate the run-off, and determine whether to shut valve 225. To perform the flow integration, the pulses output by transmitter 104 are scaled such that one pulse equals a unit amount of material. Thus, the total amount dispensed at time t (TOTₜ) is equal to the number of pulses that have occurred. For instance, if the mass flow rate ranges from 0 kg/s to 1 kg/s, and these values are mapped to 0 hz and 1000 hz, respectively, then each pulse represents 1 g of material dispensed. Total mass determination system 265 then may count pulses as they occur. The PLC program can then access TOTₜ by accessing the number of pulses that have occurred.

To estimate run-off, the 4-20 mA signal is used to determine the instantaneous mass flow rate Mₜ, which is then used to evaluate the run-off. For instance, valve closure time calculator 235 may include an analog-to-digital converter that digitizes the 4-20 mA signal. Valve closure time calculator 235 then uses the digitized value of the 4-20 mA signal, along with run-off time characteristic 250 and constant mass 245 to estimate the run-off and evaluate whether TOTₜ+X+Mₜ*Y>=target2. If valve closure time calculator 235 determines that TOTₜ+X+Mₜ*Y>=target2, then valve closure calculator 235 signals valve control system 240 that it is time to close valve 225. Valve control system consequently instructs valve controller 220 to close valve 225.

Other implementations using PLC 402 may use a single representation of the mass flow rate (e.g., 4-20 mA, pulse output, or another type of representation), or may use other combinations of one or more representations, and appropriate processing may be implemented to determine TOTₜ, estimate the run-off, and determine VCT. While the communications between transmitter 104 and PLC 402 is described as using a pulse output or 4-20 mA form, the communications between the components of systems 200 and 400 can be any industrial communications protocol. For example, the communications protocol may be a fieldbus communications protocol, as described above and further below, or a standardized high-speed (e.g. supporting 1000 updates/s) industrial digital communications protocol, such as industrial Ethernet (such as IEEE 1451) may be used. For instance, the connection between PLC 402 and transmitter 104 may be an industrial Ethernet connection.

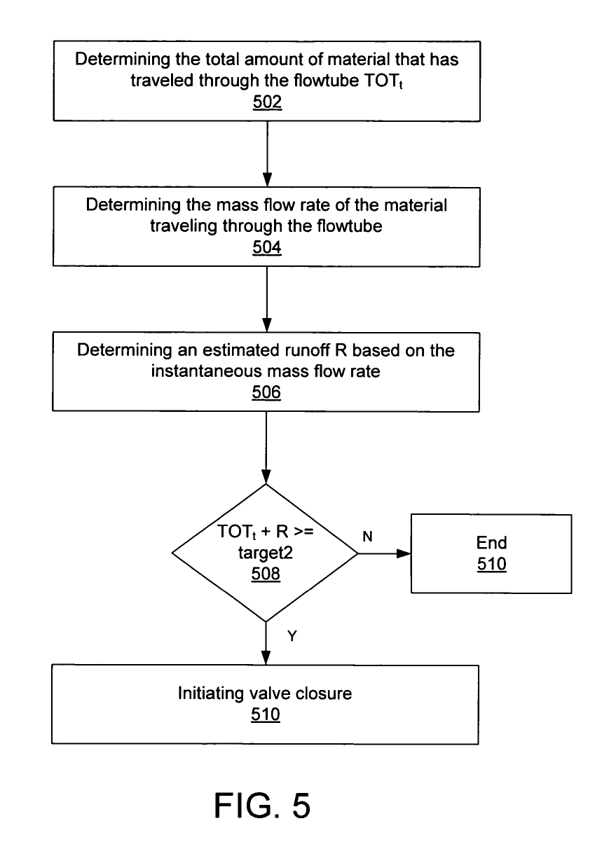

Referring to FIG. 5, digital transmitter 104 or PLC 402 generally may perform a process 500 to dynamically estimate the run-off during a batch operation based on the mass flow rate, and use the estimate of the run-off to determine the VCT. Method 500 may be performed periodically (or aperiodically) during the batch operation. For example, process 500 may be performed every time a measurement update occurs, or at some other interval.

Process 500 includes determining the total amount of material that has traveled through flowtube 215 (502). Digital transmitter 104 may determine the total amount by implementing software or hardware that performs the calculation TOTₜ=TOTₜ₋₁+MₜΔt, where TOTₜ is the total amount that has travelled through flowtube 215 up to present time t, TOTₜ₋₁ is the total mass that has travelled through flowtube 215 up to time t-1 (the time at which process 500 was last performed), Mₜ is the instantaneous mass flow rate at time t, and Δt is the interval between the last time process 500 was performed and the present time t (Δt may be the interval between measurement updates or some other interval). PLC 402 may determine the total amount by implementing software or hardware that performs pulse counting as described above, or that performs the calculation TOTₜ=TOTₜ₋₁+MₜΔt (where Δt may be the same as or different from the Δt used by digital transmitter 104).

Process 500 also includes determining the mass flow rate of the material traveling through flowtube 215 (504) and determining an estimate of the run-off based on the mass flow rate (506). Digital transmitter 104 may determine the mass flow rate using the signals from sensors 205 as described above. PLC 402 may determine the mass flow rate by reading the output(s) 404 from digital transmitter 104. The digital transmitter 104 and PLC 402 may determine the estimate of the run-off by performing the calculation R=X+M*Y, where X is a constant mass, M is the mass flow rate, and Y is the runoff time characteristic of the filling system.

Process 500 also includes evaluating whether the total amount TOTₜ, plus the estimated run-off R is greater than or equal to the target batch amount (target2) (508). If not, then process 500 ends (512). If so, then process 500 includes initiating the closure of valve 225 (510), which may be performed by digital transmitter 104 or PLC 402 by sending a valve closure signal to valve controller 220.

While the dynamic estimate of the run-off has been described with respect to varying mass flow rates, even if the mass flow rate is substantially the same at the end of each batch, the run-off during a batch operation may be dynamically estimated based on the instantaneous mass flow rate, and used to estimate the run-off when determining the VCT. For example, such techniques may be employed to improve the accuracy of systems in which the mass flow rate is substantially steady at the end of each batch. Furthermore, such techniques may be used in systems that operate with different materials, even if the mass flow rate is substantially the same at the end of each batch for a given material. When filling with a different material, the run-off amount may be different because of a difference in the mass flow rates due to differences in properties of the materials (e.g., different viscosities). Consequently, if a fixed run-off is used, the value of the fixed run-off needs to be changed when the filling material is changed. On the other hand, if the run-off is estimated dynamically, the settings of the system do not need to be changed.

In addition, while systems 200 and 400 have been described as using a digital Coriolis flowmeter, other flowmeters may be used. However, depending on the batch time, the dynamic response of the flowmeter may be an issue. In general, the dynamic response indicates how rapidly a meter is able to track changes in flow rate. One indicator of the dynamic response is the time taken for a change in mass flow rate to be reflected in the output of the flowmeter.

In general, a digital Coriolis flowmeter, such as those described in FIGS. 1A and 1B, may have a more desirable dynamic response than other flowmeters. For example, a digital Coriolis transmitter implemented with the architecture shown in FIG. 1A and according to the teachings of U.S. Pat. No. 6,311,136 has been developed by Oxford University (UK) (referred to herein and in the accompanying figures as the “Oxford” Coriolis transmitter, and when coupled with a flowtube, as the “Oxford” Coriolis flowmeter). This Coriolis transmitter has a dynamic response (in terms of time taken for a step change in mass flow rate to reflected on the transmitter outputs) in the range of 20-50 ms. A commercial version of the Oxford Coriolis transmitter is available from Invensys Systems, Inc. of Foxboro, Mass. under the model name CFT50 and has a similar dynamic response.

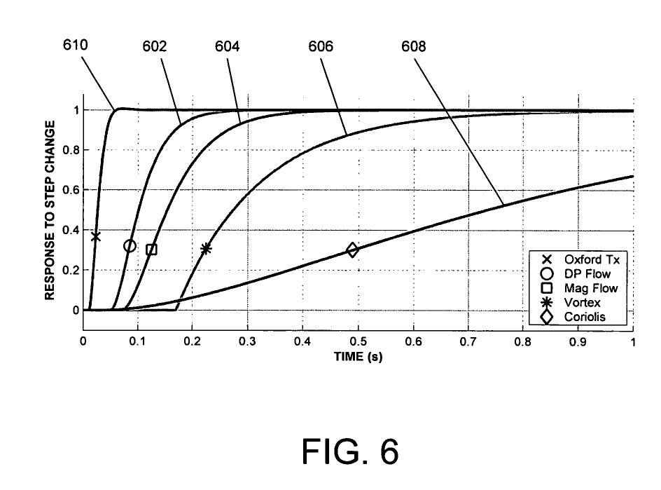

Referring to FIG. 6, the nominal step response of a variety of flowmeters is shown. In particular, FIG. 6 illustrates the dynamic response of several flowmeter technologies, including differential pressure (DP) with orifice plate 602, electromagnetic 604, vortex 606, and Coriolis 608. FIG. 6 shows, for the fastest meter in each class, the response to an instantaneous unit step change in the true mass flow rate, based on selected parameter values.

As can be appreciated from FIG. 6, there are at least two aspects to the dynamic response—an initial ‘deadtime’ where there is no change in output, and then a first or second-order response towards the new steady-state value. In FIG. 6, DP/orifice plate 602 is shown to have the fastest response, while Coriolis has the slowest 608. However, the fastest response curve 610 in FIG. 6 is the performance of the Oxford flowmeter. As shown, the dead time is 10-16 ms, and the new steady state value is achieved within a further 20-30 ms.

To determine the step response 610 of the Oxford Coriolis flowmeter shown in FIG. 6, an estimate of the dead time of the Oxford Coriolis transmitter was determined, and the dead time and overall response was confirmed experimentally. An estimate of the dead time is as follows. Although the codec samples at 40 kHz, there is a 61 sample ‘group delay’ between input and output, equivalent to a 1.5 ms dead time. Filtering in the FPGA takes 1 ms. For a typical drive frequency of 80 Hz, there is a delay of approximately 6 ms (per half-cycle) for data acquisition. The processor requires a further 1.5 ms to perform the measurement calculation. The output is updated immediately after each measurement calculation has been completed, and there are negligible delays (<1 ms) in propagating a step change in flow rate through to the output, even for low flow rates.

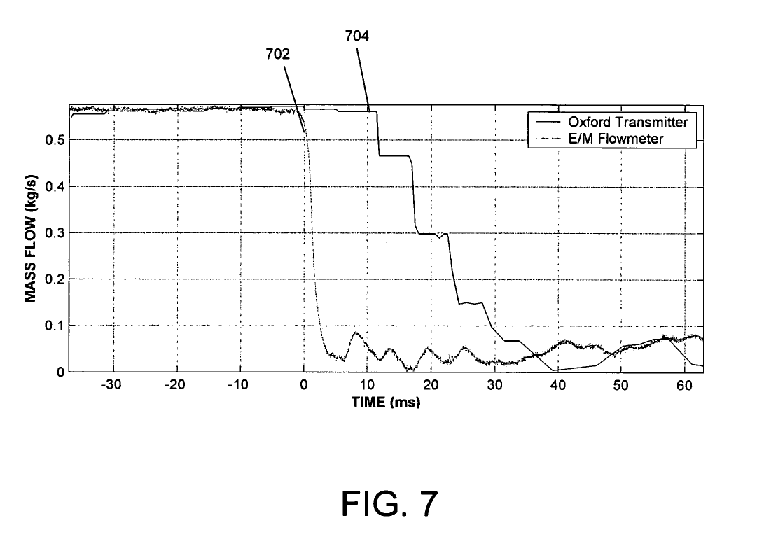

The high precision of the measurement calculation and frequency generation of the Oxford transmitter means that no averaging or filtering is required to provide a smooth measurement output, which results in a much improved dynamic response. Overall, this analysis suggests a total dead time of 10-16 ms from sensor signal input through to output, depending on where in the half-cycle a step change occurs. This estimate is similar to the theoretical limit for an 80 Hz drive frequency, and has been confirmed by experimental results, as described with respect to FIG. 7.

Referring to FIG. 7, the results of a step response test using the Oxford Coriolis flowmeter are shown. In FIG. 7, an experimental water flow test rig was used. The rig was capable of generating fast steps in flow, e.g., 0.6 to 0.1 kg/s within 3 ms. An electromagnetic flowmeter with continuous dc excitation provided a dynamically responsive indication of the time-course of the step.

The Coriolis pulse output and the electromagnetic flowmeter were recorded simultaneously, and FIG. 7 shows the observed pulse output after a fast (3 ms) step change in the mass flow rate. The electromagnetic flowmeter is indicated by line 702 and the Coriolis flowmeter is indicated by line 704. The pulse output 704 has a staircase form, as updates are 10 provided twice per drive cycle, i.e. every 6 ms. The electromagnetic flowmeter signal 702 provides the reference time-history for the massflow step, which occurs at t=0 ms. The transmitter output 704 responds at t=12 ms and the step is completed some 23 ms later.

The following discussion generally describes sources of delay in a Coriolis mass flowmeter. In the discussion below, the term ‘delay’ is used to denote both dead-time and step response elements of the dynamic response of the meter.

Generally, a mechanical response of a flowtube to a step change in flow rate is not observed over a period of less than one complete cycle of the driven motion. Thus, for example, a flowtube oscillating at 100 Hz may not respond more rapidly than 10 ms, while a 1 kHz flowtube might respond in one millisecond.

The flowtube design may have an affect on the dynamic response. For example, recent trends have seen increasing adoption of “straight” as opposed to “bent” flowtube geometries. Claimed benefits include easier installation and cleaning, reduced cost, and lower pressure drop. The design constraints for a straight geometry lead to high frequency, low amplitude oscillations, providing mixed benefits from a dynamic response perspective. While a high frequency (say 800 Hz vs. 80 Hz) is desirable, the lower sensor signal amplitude (say 30 mV vs. 300 mV) and lower phase difference range (say 0.4 degrees vs. 4.0 degrees) may result in a lower signal-to-noise ratio. As discussed below, this may necessitate measurement filtering, which may be one of the most significant causes of transmitter-induced delay.

For a digital Coriolis transmitter, the processing within the transmitter may also affect the dynamic response. Within the Coriolis transmitter, data processing may occur in several stages. The sensor signals from the flowtube are usually sampled via analog-to-digital converters in the transmitter. In some cases, additional filtering may be applied. Each step introduces some delay. Within the transmitter processor, measurement calculations may not be carried out continuously, but typically once every one or more drive cycles.

It is possible to identify two stages within this delay. Firstly, sufficient measurement data must be accumulated (e.g., one complete drive cycle), then the calculation itself takes place. For an intensive calculation, it is computationally optimal for such calculations to take as long as the data collection period, and for the two operations to carry on in parallel. Thus, one drive cycle may be required to collect data, then a further drive cycle to process it, leading to an overall delay of two drive cycles between the first datum of a step change being read by the analog-to-digital converters and the corresponding change appearing in the measurement data calculated by the processor.

In many industrial applications, one important yardstick of dynamic response is the time taken for a change in flow to be communicated via the transmitter outputs (e.g. 4-20 mA, pulse or fieldbus). An update to the transmitter output circuitry is not necessarily provided every time a new measurement value is calculated. Given the conventional scanning rates of industrial control systems, it is more typical for updates to be provided at a rate of 10 Hz or slower. The most accurate representation of the measurement data over the last, e.g., 100 ms would be its average over the measurement update period. This introduces on average, e.g., 50 ms delay in the response of the flowmeter. Furthermore, it is common to introduce additional filtering at this stage, in order to smooth the reported measurement value. With time constants of typically 40-1000 ms, such filtering can be the most significant influence in the dynamic response of commercial meters. The filtering issue is discussed further, below.

One transmitter design approach with implications for dynamic response is what may be called a “partitioned architecture,” where some electronics and processing reside at the flowtube while the rest is in a conventional housing at a greater distance. This architecture offers several advantages, such as reducing the distance and hence noise pickup between the sensors and front-end electronics, and reduced wiring costs between flowtube and transmitter housing, as typically only 4 wires are needed for power and communications. This architecture may be particularly effective for low-level signals from a straight tube. However, for intrinsic safety, the on-tube electronics and flowtube drivers share the same limited power supply, which may restrict the processing power that can be deployed at the flowtube, including its communication bandwidth; equally, this limits the electrical power available to the flowtube driver (e.g. in two-phase flow situations). A partitioned architecture introduces an additional communication stage between the two halves of the transmitter, and hence extra delay.

Other potential sources of delay include communication between the Coriolis Meter and a Control/Monitoring System. As described above, there are presently three classes of commonly-used industrial communication protocols. First, there is 4-20 mA, where the flow rate is mapped onto an analog current signal between 4 and 20 mA. There is no delay in propagating the signal to the monitoring system, but there can be delay in the analog current circuitry. Furthermore, in the monitoring system, the signal is sampled using an analog-to-digital converter, which in the process control industry typically operates at 10 Hz or slower, leading to a further 50 ms or more average delay before the measurement is received by the monitoring processor.

Second, there is pulse (frequency) output, which generally includes a square wave signal in which the frequency of the pulse stream gives an indication of the instantaneous flow rate. This has some of the advantages of 4-20 mA, being simple, unidirectional and continuous, while the discrete signal edges give some benefits of digital transmission, including higher precision. There are delays inherent in this technique, however. Typically the upper limit on the output is about 10 kHz. Also zero flow is often mapped onto zero Hz, so that at low flow rates there can be non-trivial delays in propagation due to the timing between edges—for example at 200 Hz there is a 5 ms period between rising edges. If the pulse output frequency is only updated, e.g., after each rising edge, then this can lead to several milliseconds delay in propagating a step change from a low to a high flow value.

Third, fieldbus communications (including, for example, HART and Modbus) may be used. Various digital communication protocols allow the transmission of measurement data in floating point format, with no loss of precision. Again, typically in the process industries, measurement data is transmitted no more frequently than every 100 ms, which places a lower limit on the overall dynamic response of the meters. One option offered by at least one vendor of a split architecture transmitter is direct communication with the processor local to the transducer, thus reducing communication delay.

Adoption of standardized, high-speed (e.g. supporting 1000 updates/s) digital communications may benefit applications where dynamic response is important. For instance, industrial Ethernet and, in particular, the IEEE 1451 standard may be used between halves of a split architecture transmitter. However, when such standards are unavailable, a precise pulse/frequency output coupled to a fast PLC (with system decisions taken at up to 1 ms) may be used as an alternative (or may be used in addition to such standards).

With respect to filtering, automation professionals are generally familiar with applying filtering to the outputs of field instruments. Such filtering is now normally implemented digitally within the instrument, offering the user a wide range of filter time constants. It is used for at least two reasons: to suppress unwanted process noise (for example to avoid disturbing a control loop) and/or to suppress measurement noise introduced by the instrument itself.

In short batching applications with rapidly changing flows, the intention is to preserve as much of the process dynamics as possible, so that there may not be a need to filter the process variable. Hence, measurement filtering (which typically is responsible for the greatest delay in the dynamic response analysis) is only generally used if required to suppress instrument noise. Thus, the precision of the flowmeter (as determined by such factors as the signal-to-noise ratio on the sensor signals, and the power and sophistication of the signal processing techniques) is another indirect determinant of its dynamic response, because it determines how much filtering, if any, is needed.

Also, the use of a zero cut-off is arguably a form of “filtering.” This sets a minimum threshold below which the reported flow is given as zero. While this can be useful (e.g. with two-phase flow), it also may be used to hide unflattering measurement noise in the absence of real process flow. In the examples which follow, the flow-zero option is disabled.

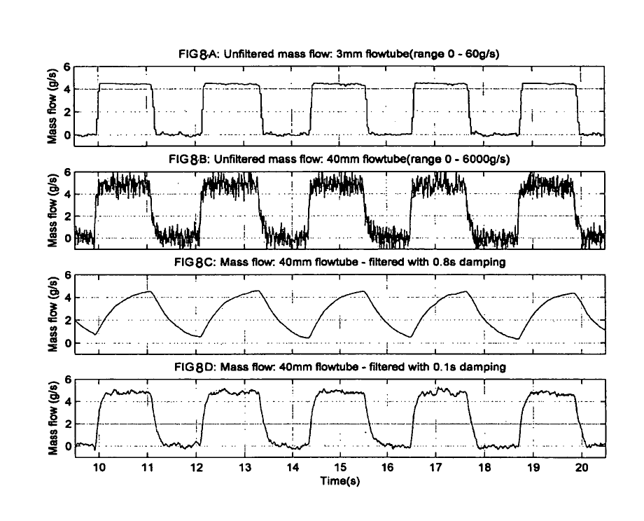

FIGS. 8A-8D are graphs showing a response of 3 mm and 40 mm flowtubes to a step change. In FIGS. 8A-8D, an interaction between measurement precision and filtering is illustrated, which shows data from two Oxford transmitters, one driving a 3 mm flowtube (nominal capacity 60 g/s) and the other a 40 mm flowtube (nominal capacity 6000 g/s). The flowtubes were arranged in series and both subjected to a series of short bursts of gas flow of 5 g/s with zero flow between pulses. Data from the 3 mm meter was sent to the 40 mm meter via a pulse output channel, so that the two flow rates can be compared more or less simultaneously.

FIG. 8A shows the measurement from the 3 mm meter without filtering—it can be seen that there is very little noise, and the dynamic response to each step change is fast, so no filtering may be needed here. Note also that this is despite being transmitted and received in the form of a pulse waveform.

FIG. 8B shows the unfiltered data from the 40 mm flowtube. Although the step change can be seen, and the dynamic response is similar to that from the 3 mm tube, the precision of the measurement is far worse and there is a high degree of noise. This may stem from the fact that the gas flow rate of 5 g/s is less than one thousandth of the nominal capacity of the 40 mm flowtube; that is, the meter has been very poorly sized for this duty. However, this performance also may be considered to represent a better-sized, but less precise meter, in which case some filtering may be required.

FIG. 8C shows the same data with a relatively heavy filter applied, having a time constant of 0.8 s. The data is now smooth, but is a very poor representation of the true gas flow, and the step response has been slowed considerably. In FIG. 8D, a filter time constant of 0.1 s provides a reasonable balance between noise suppression and loss of dynamic response.

In summary, where a fast dynamic response is required, filtering may be used with care where required, but ideally the meter should be sufficiently precise that filtering should be unnecessary.

Another area of interest in studying dynamic responses of flowmeters concerns the sources of noise in the coriolis measurement signal. While there is a background noise “floor” as with any other instrument, there are significant contributions from other modes of vibration of the flowtube. For example, coriolis flowtubes, like other mechanical structures, have several modes of vibration; usually the drive mode is the lowest frequency mode. The mode above (and, where it exists, the mode below) the drive mode has special significance and is called the ‘coriolis mode,’ as the coriolis force(s) used to detect mass flow act in this mode of vibration.

Roughly speaking, the closer the frequencies of these two modes, the greater the sensitivity (in terms of phase difference per kg/s) of the flowtube. The relative placing of these modes is an issue in flowtube design. However, from a signal processing point of view, the proximity of other modes of vibration brings potential problems. While the amplitude of vibration in the drive mode is actively controlled by the transmitter, the other modes of vibration are readily excited to low levels of amplitude by, for example, external vibration or flow noise.

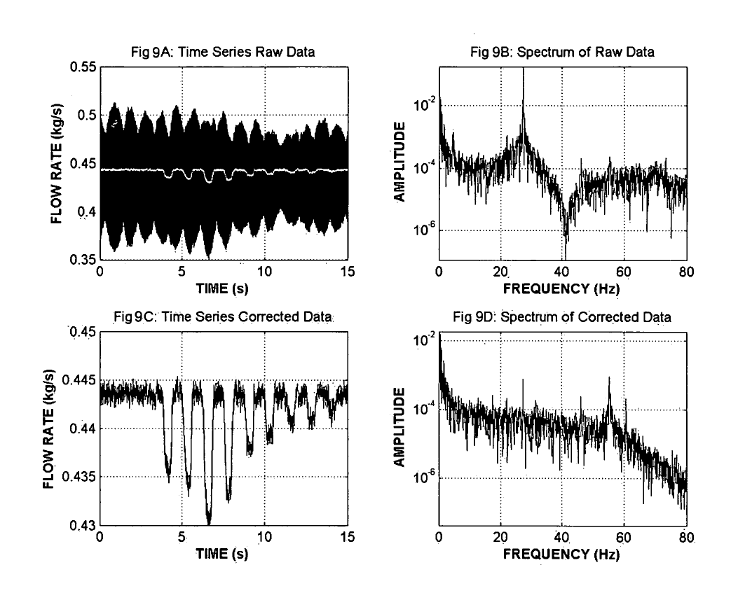

FIGS. 9A-9D are graphs showing raw and corrected data for the configuration(s) of FIGS. 8A-8D, with small step changes. FIGS. 9A-9D illustrate that rapid flow steps will generally excite the coriolis mode(s) of vibration. These modes naturally have long decay times, and so the sensor signals from the flowtube are almost continuously contaminated with random low level amplitudes of one or more modes of vibration. For example, a B-shaped, dual drive flowtube may use the second mode of vibration as the drive mode. A 12 mm tube filled with water vibrates in this mode at 82.6 Hz. The lower coriolis mode resonates at 54.9 Hz. The presence of small levels of coriolis mode in the sensor signal results in relatively significant noise in the phase difference calculation at the beat frequency between the two i.e. at 27.7 Hz.

This is illustrated in FIG. 9A, which shows the time series of raw mass flow during a series of step changes in flow. FIG. 9B shows the corresponding power spectrum. The beat frequency at 28 Hz dominates the spectrum and the flow steps cannot be observed in the time series.

It is thus desirable to eliminate the influence of the coriolis mode on the sensor signal. One approach is to use a low- or high-pass filter on the raw sensor data, which results in a trade-off between flowtube sensitivity (requiring the modes to be close together), and effective filtering (which requires the modes to be far apart). For the relatively high sensitivity B-tube, and for a sampling rate of 40 kHz, the 82 Hz and 55 Hz modes may be too close together to be separated by filtering of the sensor data.

Another solution is to suppress the noise through filtering of the flow measurement itself, with all the implications for dynamic response discussed previously. As another alternative, specific signal processing techniques may be used. FIGS. 9C and 9D show the effect of a correction technique applied on-line which suppresses the influence of the coriolis mode, without any detrimental effect on the dynamic response of the flowtube. In these figures, the 28 Hz mode has been suppressed within the spectrum, and the corresponding time series is cleaner, so that the small step changes become apparent. For comparison, the white trace in FIG. 9A is the corrected data superimposed upon the noisier raw data signal.

A number of implementations have been described. Nevertheless, it will be understood that various modifications may be made. For example, while the foregoing describes estimating the run-off using a linear relationships, arbitrarily complex relationships may be developed and used. In addition, in some implementations, other flow integration calculations may be performed to determine the total amount of material dispensed. For instance, instead of using TOTₜ=TOTₜ₋₁+MₜΔt, a flow integration equation such as TOTₜ=TOTₜ₋₁+Δt((Mₜ+Mₜ₋₁)/2), otherwise referred to as trapezoidal integration.

Furthermore, while the foregoing has described the amount of material being dispensed in terms of mass, and estimating the run-off using mass flow rate, other types of measurements and flow rates may be used. For example, the amount of material to be dispensed may be measured in volume, and the volumetric flow rate may be measured to estimate the run-off of the material and determine when valve 225 should be closed to attain a target volume of material.

In addition, while the estimation of the run-off and control of the valve has been shown as being performed by a Coriolis transmitter or PLC, other devices may perform such estimation and control from a flow rate reading provided by a flowmeter. For example, distributed control system may be used to perform the estimation and/or control. As another alternative, a flow computer could perform the estimation and/or control. In a Foundation Fieldbus system, the estimation and/or control could be performed by a Function Block anywhere in the system.

Accordingly, other implementations are within the scope of the following claims.

1. A method of operating a filling system, the method comprising:
opening a valve to start a flow of material through a conduit;
while the material is flowing through the conduit:
determining a total amount of the material that has flowed through the conduit;
determining a flow rate of the material flowing through the conduit;
estimating a run-off amount of the material flowing through the conduit based on the flow rate;
determining that the total amount of the material that has flowed through the conduit plus the run-off amount is greater than or equal to a target amount;
in response to determining that the total amount of the material that has flowed through the conduit plus the run-off amount is greater than or equal to a target amount, initiating a closure of the valve to stop the flow of material through the conduit.

2. The method of claim 1 wherein determining the total amount of the material that has flowed through the conduit comprises calculating TOTₜ=TOTₜ₋₁+MₜΔt, where TOTₜ is the total amount of the material that has flowed through the flowtube up to present time t, TOTₜ₋₁ is the total amount of the material that has flowed through flowtube up to time t-1, Mₜ is the flow rate at time t, and Δt is the interval between time t and t-1.

3. The method of claim 1 wherein determining the total amount of the material that has flowed through the conduit comprises counting pulses output by a Coriolis flowmeter, wherein each pulse output by the Coriolis flowmeter represents a unit amount of material.

4. The method of claim 1 wherein determining the flow rate of the material flowing through the conduit comprises:
oscillating the conduit;
sensing a property of the oscillation of the conduit; and
calculating the flow rate based on the sensed property.

5. The method of claim 1 wherein determining the flow rate of the material flowing through the conduit comprises reading a signal from a Coriolis flowmeter, wherein the signal indicates the flow rate.

6. The method of claim 1 wherein estimating the run-off amount comprises calculating R=X+Mₜ*Y, where R is the estimated run-off amount, X is a constant amount, Mₜ is the flow rate at present time t, and Y is a run-off time characteristic.

7. The method of claim 1 wherein initiating the closure of the valve to stop the flow of material through the conduit comprises initiating the closure of the valve less than about 5 seconds after opening the valve.

8. The method of claim 1 wherein the total amount is a total mass, the flow rate is a mass flow rate, and the target amount is a target mass.

9. The method of claim 1 wherein the total amount is a total volume, the flow rate is a volumetric flow rate, and the target amount is a target volume.

10. A flowmeter transmitter comprising:
a parameter determination system configured to determine a flow rate of a material traveling through a flowtube; and
a batch control system configured to estimate a run-off amount of the material based on the flow rate and to determine a valve closure time for a valve associated with the flowtube based on the estimated run-off amount.

11. The flowmeter transmitter of claim 10 wherein the parameter determination system is configured to determine a total amount of material that has travelled through the flowtube, and the batch control system is configured determine the valve closure time based on the estimated run-off amount and the total amount of material that has travelled through the flowtube.

12. The flowmeter transmitter of claim 11 wherein the total amount is a total mass, the flow rate is a mass flow rate, and the target amount is a target mass.

13. The flowmeter transmitter of claim 11 wherein the total amount is a total volume, the flow rate is a volumetric flow rate, and the target amount is a target volume.

14. The flowmeter transmitter of claim 11 wherein the parameter determination system is configured to determine the total amount of material that has travelled through the flowtube by performing the following calculation: TOTₜ=TOTₜ₋₁+MₜΔt, where TOTₜ is the total amount of the material that has travelled through the flowtube up to present time t, TOTₜ₋₁ is the total amount of the material that has travelled through flowtube up to time t-1, Mₜ is the flow rate at time t, and Δt is the interval between time t and t-1.

15. The flowmeter transmitter of claim 10 wherein the batch control system is configured to determine the valve closure time by determining whether TOTₜ+R>=target2, where TOTₜ is the total amount of material that has travelled through the flowtube up to present time t, R is the estimated run-off amount, and target2 is a target amount.

16. The flowmeter transmitter of claim 15 wherein the batch control system is configured to estimate the run-off amount by calculating R=X+Mₜ*Y, where R is the estimated run-off amount, X is a constant amount, Mₜ is the flow rate at present time t, and Y is a run-off time characteristic.

17. The flowmeter transmitter of claim 10 wherein the batch control system is configured to initiate closing of the valve when the valve closure time occurs.

18. The flowmeter transmitter of claim 10 wherein the flowmeter transmitter is a digital Coriolis flowmeter transmitter.

19. A filling system comprising:
a conduit to receive a flow of material;
a valve to start and stop the flow of material through the conduit
at least one sensor connected to the conduit; and
one or more processing devices to receive a sensor signal from the sensor and configured to determine a flow rate of the flow of material based on the sensor signal, to estimate a run-off amount of the flow of material based on the flow rate, and to determine a valve closure time based on the estimate of the run-off amount.

20. The filling system of claim 19 wherein the one or more processing devices are configured to determine a total amount of material that has flowed through the conduit and to determine the valve closure time based on the estimated run-off amount and the total amount of material that has flowed through the conduit.

21. The filling system of claim 20 wherein the total amount is a total mass, the flow rate is a mass flow rate, and the target amount is a target mass.

22. The filling system of claim 20 wherein the total amount is a total volume, the flow rate is a volumetric flow rate, and the target amount is a target volume.

23. The filling system of claim 20 wherein the one or more processing devices are configured to determine the total amount of material that has flowed through the conduit by performing the following calculation: TOTₜ=TOTₜ₋₁+MₜΔt, where TOTₜ is the total amount of the material that has flowed through the conduit up to present time t, TOTₜ₋₁ is the total amount of the material that has flowed through conduit up to time t-1, Mₜ is the flow rate at time t, and Δt is the interval between time t and t-1.

24. The filling system of claim 19 wherein the one or more processing devices are configured to determine the valve closure time by determining whether TOTₜ+R>=target2, where TOTₜ is the total amount of material that has flowed through the conduit up to present time t, R is the estimated run-off amount, and target2 is a target amount.

25. The filling system of claim 24 wherein the one or more processing devices are configured to estimate the run-off amount by calculating R=X+Mₜ*Y, where R is the estimated run-off amount, X is a constant amount, Mₜ is the flow rate at present time t, and Y is a run-off time characteristic.

26. The filling system of claim 19 wherein the one or more processing devices comprise a digital Coriolis transmitter processor configured to determine the flow rate of the flow of material based on the sensor signal, to estimate the run-off amount of the flow of material based on the flow rate, and to determine the valve closure time based on the estimate of the run-off amount.

27. The filling system of claim 19 wherein the one or more processing devices comprise:
a digital Coriolis transmitter processor configured to determine the flow rate of the flow of material based on the sensor signal; and
a programmable logic controller configured to estimate the run-off amount of the flow of material based on the flow rate, and to determine the valve closure time based on the estimate of the run-off amount.

28. The filling system of claim 27 further comprising an industrial Ethernet connection between the digital Coriolis transmitter and the programmable logic controller.

29. The filling system of claim 27 further comprising a fieldbus communications connection between the digital Coriolis transmitter and the programmable logic controller.
